(19) United States
(12) Patent Application Publication
(10) Pub. No.: US 2017/0024784 A1
(43) Pub. Date: Jan. 26, 2017

(54) Computer System and Cost Calculating Method

(71) Applicant: Hitachi, Ltd., Tokyo (JP)

(72) Inventors: Kunihiko KIDO, Tokyo (JP); Kumiko SETO, Tokyo (JP)

(21) Appl. No.: 15/039,088

(22) PCT Filed: Nov. 29, 2013
(86) PCT No.: PCT/JP2013/082146

§ 371 Date: May 25, 2016

(51) Int. Cl. G06Q 30/02; G06F 19/00

(52) U.S. Cl. CPC G06Q 30/0283; G06F 19/3443

(57) ABSTRACT

There is provided a computer system that calculates a cost of diagnostic treatment for a patient in a medical institution. The computer system stores a healthcare information database and a medical-knowledge management database and includes an adjustment-coefficient calculating section that calculates, using the healthcare information database and the medical-knowledge-management database, an adjustment coefficient for adjusting costs of diagnostic treatment corresponding to the patient and a cost calculating section that calculates a cost using the calculated adjustment coefficient. The adjustment-coefficient calculating section calculates, on the basis of consistency of the healthcare information database and the medical-knowledge management database, a first value indicating the quality of medical services for the patient, calculates a second value indicating severity of the patient, specifies a demographic factor of the patient, calculates a third value indicating the demographic factor of the patient, and calculates the adjustment coefficient on the basis of the quality of the medical services for the patient, the severity of the patient, and the demographic factor of the patient.

### TECHNICAL FIELD

The present invention relates to a computer system that processes healthcare information and a method of calculating costs using the healthcare information.

### BACKGROUND ART

As a background art in a technical field related to the present invention, there is Patent Literature 1. Patent Literature 1 describes that various costs are calculated in a process for calculating a marginal profit ratio per labor cost and an investment per labor cost. It is known that, when a cost adjustment coefficient for each of care episodes is calculated, information concerning demographics and severity is used as an explanatory variable.

The care episodes indicate medical services (diagnostic treatment) provided to a patient from time when the patient complains about a health problem, that is, a disease first until the patient takes the last medical advice concerning the same health problem and treatment ends. In the following explanation, the care episodes are simply described as episodes.

### CITATION LIST

### Patent Literature

Patent Literature 1: JP-A-2010-218448

### SUMMARY OF INVENTION

### Technical Problem

In efficiency evaluation of hospitals, medical treatment events are grouped and costs are totalized for each of a series of episodes including diseases and complications and comparison among the hospitals or among doctors is performed for each of the episodes. When the efficiency evaluation is performed, since costs are higher for higher severity such as a larger number of complications or patients in higher ages, even if costs are simply tabulated, the comparison among the hospitals or among the doctors cannot be performed. Therefore, in general, adjustment of costs is performed on the basis of severity.

On the other hand, when the quality of diagnostic treatment is high, costs are suppressed in order to suppress an outbreak of complications or hospital readmission. However, in the cost adjustment model in the past, an effect of the quality of the diagnostic treatment is not taken into account.

It is an object of the present invention to provide a system and a method capable of realizing cost adjustment that takes into account the quality of diagnostic treatment.

### Solution to Problem

A representative example of an invention disclosed in this application is described as follows. That is, there is provided a computer system that calculates a first cost of diagnostic treatment for a patient in a medical institution, the computer system including one or more computers that include a processor, a memory connected to the processor, and an interface connected to the processor, the computer system storing a healthcare information database for managing, as episodes, a series of medical services performed on a disease of the patient and a medical-knowledge management database for managing types of the medical services recommended for a predetermined patient, contents of the medical services, and costs of the medical services, and the computer system comprising: an adjustment-coefficient calculating section that calculates, using the healthcare information database and the medical-knowledge management database, an adjustment coefficient for adjusting costs of diagnostic treatment corresponding to the patient; and a cost calculating section that calculates the first cost using the calculated adjustment coefficient. The adjustment-coefficient calculating section calculates, for each of combinations of processing target episodes and processing target patients, on the basis of consistency of the healthcare information database and the medical-knowledge management database, a first value indicating the quality of the medical services for the patient, calculates, on the basis of the healthcare information database, a second value indicating severity of the processing target patient, specifies a demographic factor of the processing target patient on the basis of the healthcare information database, calculates a third value indicating the demographic factor of the processing target patient, calculates, for each of the combinations of the processing target episodes and the processing target patients, the adjustment coefficient on the basis of the quality of the medical services for the patient, the severity of the patient, and the demographic factor of the patient, and calculates, for each of the combinations of the processing target episodes and the processing target patients, a second cost by totaling costs of the medical services for the patient. The cost calculating section calculates, for each of the combinations of the processing target episodes and the processing target patients, a third cost using the second cost and the adjustment coefficient and calculates, for each of the processing target episodes, the first cost by totaling the third cost of the patient related to the processing target episode.

### Advantageous Effect of Invention

According to the present invention, it is possible to adjust costs related to operation of a medical institution taking into account the quality of a medical service (diagnostic treatment). Consequently, it is possible to accurately perform comparison among doctors and among hospitals.

Problems, components, and effects other than those explained above are made clear by the following explanation of embodiments.

### BRIEF DESCRIPTION OF THE DRAWINGS

FIG. 1 is a block diagram showing a configuration example of a computer system in a first embodiment of the present invention.

FIG. 2 is a block diagram for explaining details of a program and information stored by a server in the first embodiment of the present invention.

FIG. 3 is a block diagram for explaining details of a program and information stored by the server in the first embodiment of the present invention.

FIG. 4 is an explanatory diagram showing an example of medical institution information in the first embodiment of the present invention.

FIG. 5 is an explanatory diagram showing an example of target episode information in the first embodiment of the present invention.

FIG. 6 is an explanatory diagram showing an example of patient information of the first embodiment of the present invention.

FIG. 7 is an explanatory diagram showing an example of episode information in the first embodiment of the present invention.

FIG. 8 is an explanatory diagram showing an example of medical practice information in the first embodiment of the present invention.

FIG. 9 is an explanatory diagram showing an example of test result information in the first embodiment of the present invention.

FIG. 10 is an explanatory diagram showing an example of prescription information in the first embodiment of the present invention.

FIG. 11 is an explanatory diagram showing an example of relation information in the first embodiment of the present invention.

FIG. 12 is an explanatory diagram showing an example of diagnostic-treatment knowledge information in the first embodiment of the present invention.

FIG. 13 is an explanatory diagram showing an example of test-adaptation disease information in the first embodiment of the present invention.

FIG. 14 is an explanatory diagram showing an example of drug-adaptation disease information in the first embodiment of the present invention.

FIG. 15A is a flowchart for explaining processing executed by a conformity/cost calculating section 201 of a cost-adjustment-coefficient calculating section in the first embodiment of the present invention.

FIG. 15B is a flowchart for explaining processing executed by the conformity/cost calculating section 201 of the cost-adjustment-coefficient calculating section in the first embodiment of the present invention.

FIG. 15C is a flowchart for explaining processing executed by the conformity/cost calculating section 201 of the cost-adjustment-coefficient calculating section in the first embodiment of the present invention.

FIG. 16 is a flowchart for explaining details of consistency check processing in the first embodiment of the present invention.

FIG. 17 is an explanatory diagram showing an example of analysis data information in the first embodiment of the present invention.

FIG. 18 is an explanatory diagram showing an example of a display screen of a calculation result in the first embodiment of the present invention.

### DESCRIPTION OF EMBODIMENTS

Embodiments of the present invention are explained below with reference to the drawings.

### First Embodiment

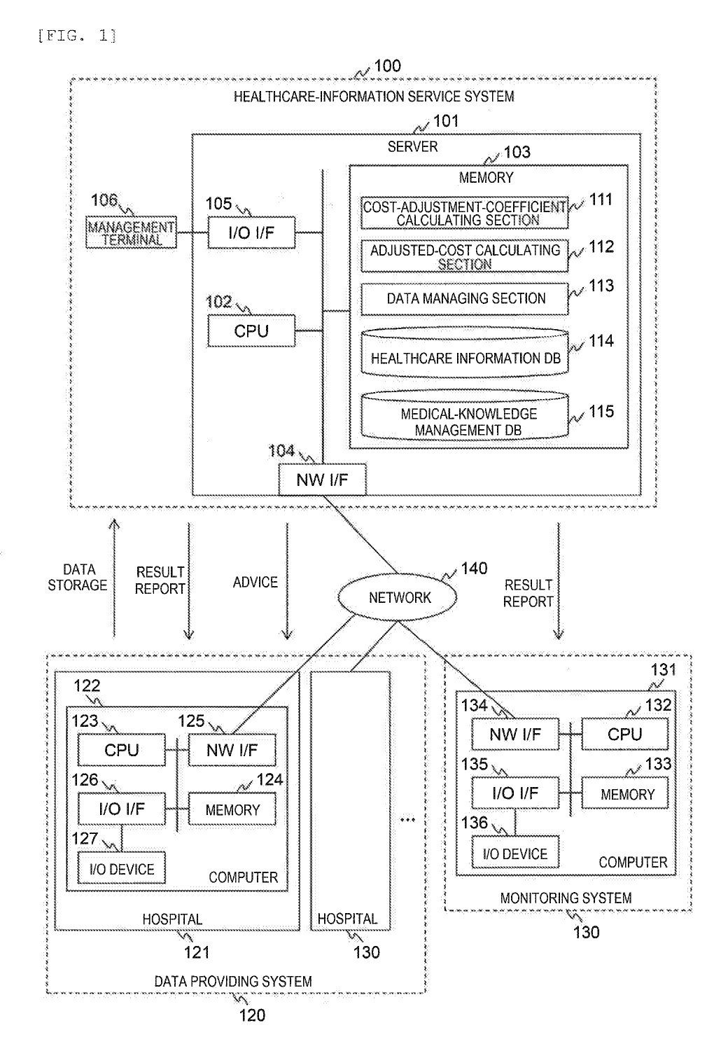

FIG. 1 is a block diagram showing a configuration example of a computer system in a first embodiment of the present invention.

The computer system is configured from a healthcare-information service system 100, a data providing system 120, and a monitoring system 130. The systems are connected via a network 140. Note that the present invention is not limited to a connection form of the network 140.

The healthcare-information service system 100 is a system operated by a provider of a healthcare information service. The healthcare-information service system 100 provides a service for storing various data such as medical test information data and medical care data provided from the data providing system 120. The medical test data includes information concerning medical practice and the like in a regular medical test. The medical care data includes information concerning a disease name, a symptom, a medical practice, prescription, and the like of each patient.

The healthcare-information service system 100 calculates cost information concerning operations of medical institutions on the basis of the provided data and reports a calculation result to medical institutions configuring the data providing system 120 or a monitoring organization that operates the monitoring system 130.

The data providing system 120 is a system operated by a medical institution such as a hospital and is configured from a plurality of medical institutions. The medical institutions request the healthcare-information service system 100 to store various medical care data and medical test data generated in the medical institutions. In this embodiment, hospitals are explained as an example of the medical institutions.

The monitoring system 130 is a system operated by the monitoring organization. The monitoring system 130 evaluates efficiency of the hospitals on the basis of the cost information of the hospitals calculated in the healthcare-information service system 100. As an example of the monitoring organization, an insurer, a government organization, and the like that pay medical service fees to the hospitals are conceivable.

The configurations of the systems are explained.

The healthcare-information service system 100 is configured from a server 101 and a management terminal 106. Note that the healthcare-information service system 100 may be configured from a plurality of servers 101.

The server 101 includes a CPU 102, a memory 103, a network interface 104, and an input/output interface 105.

The CPU 102 is an arithmetic device that executes a program stored in the memory 103. The CPU 102 can realize various functions in the healthcare-information service system 100 by executing the program.

The memory 103 stores the program executed by the CPU 102 and various kinds of information necessary for the execution of the program. The memory 103 in this embodiment stores, as programs, a program for realizing a cost-adjustment-coefficient calculating section 111, an adjusted-cost calculating section 112, and a data managing section 113. The memory 103 stores, as information, a healthcare information DB 114 and a medical-knowledge management DB 115.

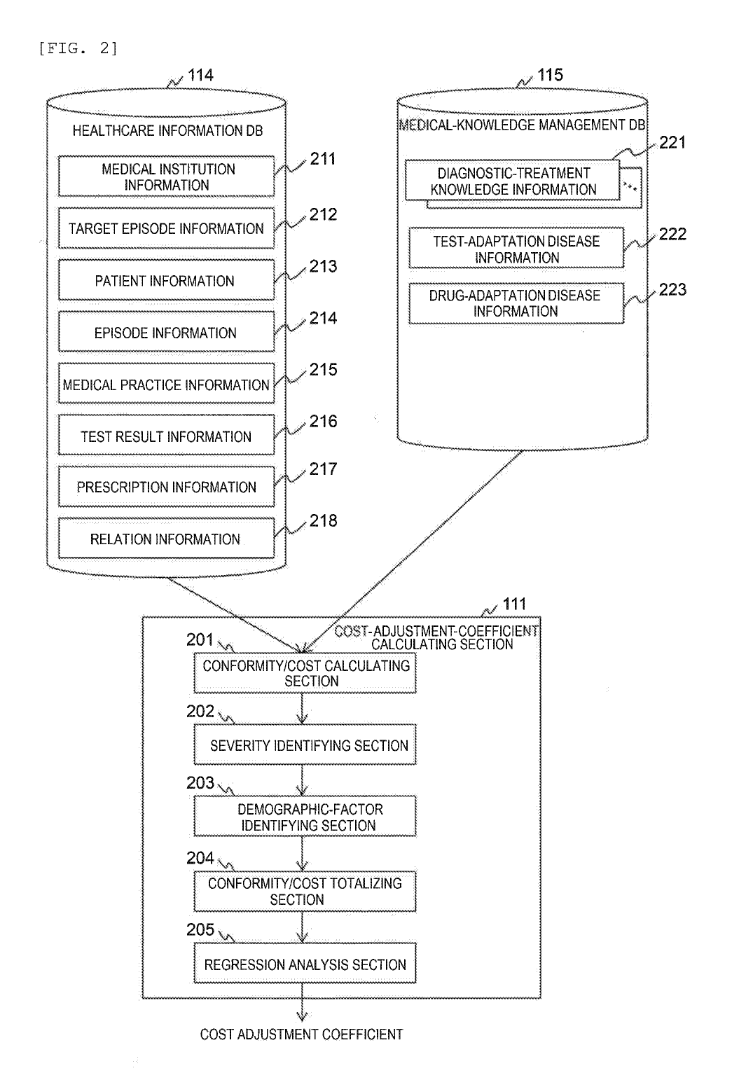

The cost-adjustment-coefficient calculating section 111 calculates a cost adjustment coefficient used during calculation of cost information of hospitals. The adjusted-cost calculating section 112 calculates adjusted costs of the hospitals on the basis of the cost adjustment coefficient. The data managing section 113 receives data transmitted from the data providing system 120 and stores various kinds of information in the healthcare information DB 114. Note that detailed configurations of the cost-adjustment-coefficient calculating section 111 and the adjusted-cost calculating section 112 are explained below with reference to FIG. 2 and FIG. 3.

The healthcare information DB 114 is a database for managing information (healthcare information) transmitted from the data providing system 120. The medical-knowledge management DB 115 is a database for managing information for evaluating the quality of diagnostic treatment and is used when a cost adjustment coefficient and adjusted costs are calculated. Information stored in the healthcare information DB 114 and the medical-knowledge management DB 115 is explained below with reference to FIG. 2.

The network interface 104 communicates with the data providing system 120, the monitoring system 130, and the like via the network 140 to thereby transmit and receive data. The input/output interface 105 manages an input to and an output from the server 101. In this embodiment, the management terminal 106 is connected via the input/output interface 105.

The management terminal 106 is a computer operated by an operator of the healthcare-information service system 100. The management terminal 106 includes input/output devices such as a keyboard, a mouse, and a display. The management terminal 106 inputs a program, data, and the like input by the operator to the server 101 and displays, for example, a calculation result of adjusted costs. In FIG. 1, the healthcare-information service system 100 is configured from one server 101. However, the healthcare-information service system 100 may be configured from a plurality of servers 101.

Note that the server 101 may include a storage device such as an HDD or an SSD. The program and the information may be stored in the storage device. In this case, the CPU 102 reads out the program and the information from the storage device and loads the read-out program and information onto the memory 103.

The data providing system 120 is configured from computers 122 included in a plurality of hospitals 121. Note that the hospital 121 may include a plurality of computers 122. The computer 122 includes a CPU 123, a memory 124, a network interface 125, an input/output interface 126, and an input/output device 127. As a program and information stored in the memory 124, a publicly-known program and publicly-known information only have to be used. Therefore, explanation of the program and the information is omitted.

A doctor, a health instructor, or the like of the hospital 121 operates the input/output device 127 of the computer 122 to thereby input medical care data and the like. The computer 122 converts the input data into a predetermined format and transmits the converted data to the server 101 of the healthcare-information service system 100 via the network 140.

The monitoring system 130 is configured from a computer 131. Note that the monitoring system 130 may be configured from a plurality of computers 131. The computer 131 includes a CPU 132, a memory 133, a network interface 134, an input/output interface 135, and an input/output device 136.

The computer 131 transmits, according to an instruction from a user of the monitoring organization, to the server 101 of the healthcare-information service system 100, a request message, a signal, a packet, or the like for requesting transmission of the calculation result of the adjusted costs. The computer 131 stores the calculation result of the adjusted costs received from the server 101. The monitoring organization is capable of performing efficiency evaluation of a hospital by analyzing the calculation result of the adjusted costs stored in the computer 131.

FIG. 2 and FIG. 3 are block diagrams for explaining details of the program and the information stored by the server 101 in the first embodiment of the present invention.

First, the configurations of the cost-adjustment-coefficient calculating section 111, the healthcare information DB 114, and the medical-knowledge management DB 115 are explained with reference to FIG. 2.

The healthcare information DB 114 stores medical institution information 211, target episode information 212, patient information 213, episode information 214, medical practice information 215, test result information 216, prescription information 217, and relation information 218. The medical-knowledge management DB 115 includes diagnostic-treatment knowledge information 221, test-adaptation disease information 222, and drug-adaptation disease information 223.

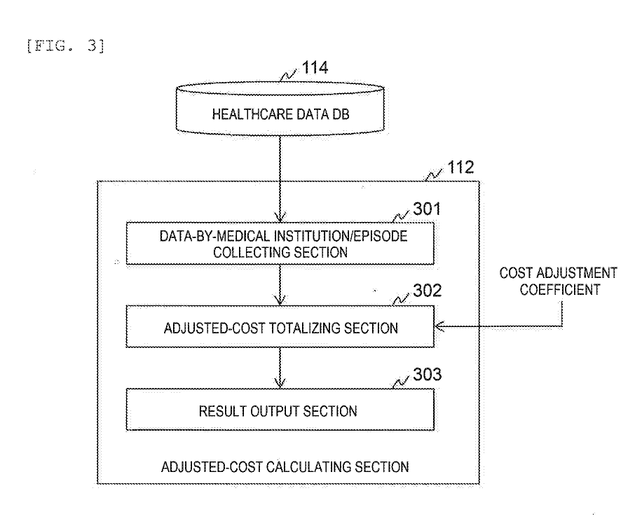

Note that details of the medical institution information 211, the target episode information 212, the patient information 213, the episode information 214, the medical practice information 215, the test result information 216, the prescription information 217, and the relation information 218 are explained below with reference to FIG. 4 to FIG. 11. Details of the diagnostic-treatment knowledge information 221, the test-adaptation disease information 222, and the drug-adaptation disease information 223 are explained below with reference to FIG. 12 to FIG. 14.

The cost-adjustment-coefficient calculating section 111 is configured from a plurality of program modules. Specifically, the cost-adjustment-coefficient calculating section 111 includes a conformity/cost calculating section 201, a severity identifying section 202, a demographic-factor identifying section 203, a conformity/cost totalizing section 204, and a regression analysis section 205.

The conformity/cost calculating section 201 calculates, on the basis of various kinds of information stored in the healthcare information DB 114 and the medical-knowledge management DB 115, for each episode, conformity to information stored in the medical-knowledge management DB 115 and costs. The severity identifying section 202 calculates severity for each episode. The demographic-factor identifying section 203 calculates demographic factors such as age and sex of a patient related to an episode. The conformity/cost totalizing section 204 totalizes conformity and costs for each episode related to a target episode. The regression analysis section 205 calculates a cost adjustment coefficient on the basis of the conformity, the costs, the severity, and the demographic factors.

The present invention has a characteristic in that the cost-adjustment-coefficient calculating section 111 adds the conformity as an explanatory variable and calculates the cost adjustment coefficient. By adding the conformity to the explanatory variable, it is possible to incorporate an effect of the quality of diagnostic treatment with respect to costs. That is, by including efforts of a hospital (a data provider) concerning the quality of the diagnostic treatment in the cost adjustment coefficient, an incentive to improve the quality of the diagnostic treatment acts in the hospital.

The configuration of the adjusted-cost calculating section 112 is explained with reference to FIG. 3.

The adjusted-cost calculating section 112 is configured from a plurality of program modules. Specifically, the adjusted-cost calculating section 112 includes a data-by-medical-institution/episode collecting section 301, an adjusted-cost totalizing section 302, and a result output section 303.

The data-by-medical-institution/episode collecting section 301 generates a list of patients and a list of target episodes. The adjusted-cost totalizing section 302 totalizes costs on the basis of the list of patients and the list of target episodes. The result output section 303 outputs cost information, which is a totalization result.

Details of processing executed by the cost-adjustment-coefficient calculating section 111 and the adjusted-cost calculating section 112 are explained below.

Details of information stored in the healthcare information DB 114 and the medical-knowledge management DB 115 are explained.

FIG. 4 is an explanatory diagram showing an example of the medical institution information 211 in the first embodiment of the present invention.

The medical institution information 211 is information for managing a medical institution, which is a data provider. The medical institution information 211 includes a medical institution ID 401 and a medical institution name 402.

The medical institution ID 401 is an identifier for identifying the medical institution. The medical institution name 402 is a name of the medical institution.

The medical institution information 211 is information generated by a provider of the healthcare information service.

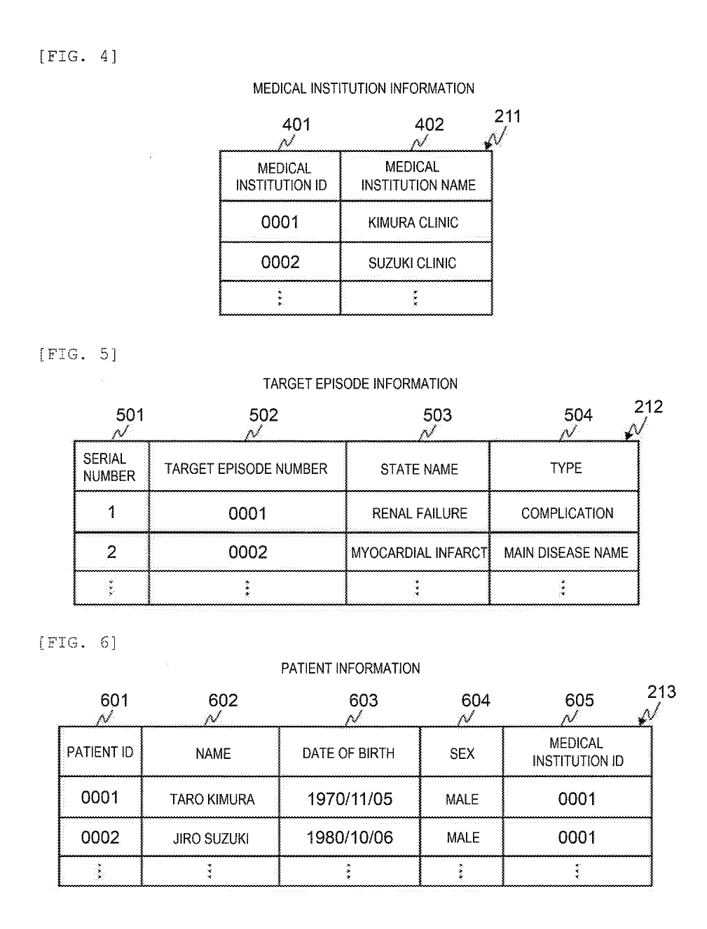

FIG. 5 is an explanatory diagram showing an example of the target episode information 212 in the first embodiment of the present invention.

The target episode information 212 is information for managing an analysis target episode. The target episode information 212 includes a serial number 501, a target episode number 502, a state name 503, and a type 504.

The serial number 501 is an identification number for identifying a record registered in the target episode information 212. The target episode number 502 is an identification number for identifying a target episode. The state name 503 represents an episode. A disease name, a complication, a comorbidity, and the like are stored in the state name 503. The type 504 is information indicating which of a main disease name and a complication the episode corresponding to the state name 503 is.

The target episode information 212 is information generated by a provider of a healthcare information service. Specifically, the provider operates the management terminal 106 and instructs generation of the target episode information 212. The data managing section 113 generates the target episode information 212 according to the instruction.

Data provided by the data provider is arranged for each target episode and managed on the basis of the target episode information 212.

FIG. 6 is an explanatory diagram showing an example of the patient information 213 in the first embodiment of the present invention.

The patient information 213 is information for managing basic information of a patient. The patient information 213 includes a patient ID 601, a name 602, a date of birth 603, sex 604, and a medical institution ID 605.

The patient ID 601 is an identifier for identifying the patient. The name 602 is a name of the patient. The date of birth 603 is a date of birth of the patient. The sex 604 is sex of the patient. The medical institution ID 605 is an identifier for identifying a medical institution that the patient consults.

The patient information 213 is generated on the basis of data provided to the data managing section 113 from the data providing system 120. Specifically, the data managing section 113 receives data from the computer 122 of the hospital 121 and stores the received data in the patient information 213.

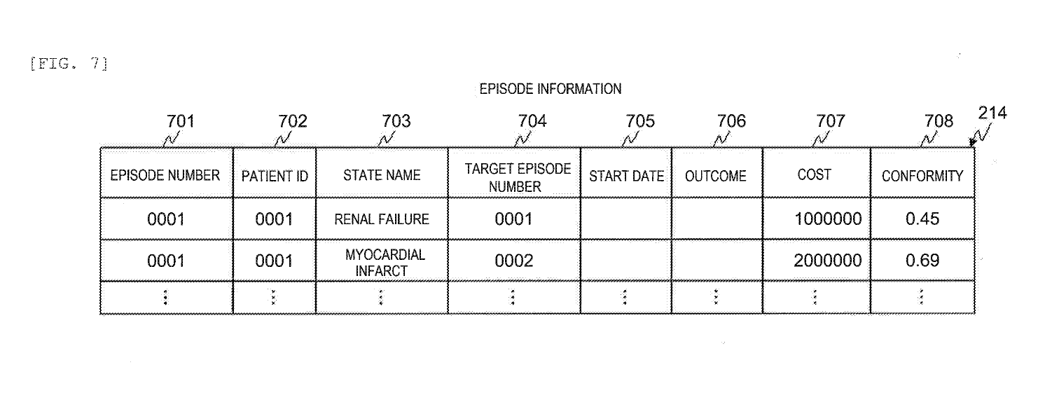

FIG. 7 is an explanatory diagram showing an example of the episode information 214 in the first embodiment of the present invention.

The episode information 214 is information for managing an episode. The episode information 214 includes an episode number 701, a patient ID 702, a state name 703, a target episode number 704, a start date 705, an outcome 706, a cost 707, and conformity 708.

The episode number 701 is an identification number for identifying a record (an episode) registered in the episode information 214. The patient ID 702 is an identifier for identifying a patient related to the episode. The state name 703 represents the episode. The target episode number 704 is an identification number of a target episode related to the episode. As explained below, the target episode information 212 is referred to on the basis of the target episode number 704.

The start date 705 is a start date of the episode. The outcome 706 indicates a consequence of the episode such as healing or fat. The cost 707 is a total value of costs related to the episode. The conformity 708 is a value calculated on the basis of the medical-knowledge management DB 115 with respect to data related to the episode.

The conformity 708 is a value indicating conformity of performed diagnostic treatment to content of diagnostic treatment recommended for the episode. The conformity 708 is used as an indicator representing the quality of diagnostic treatment in the hospital 121.

In the episode number 701, the patient ID 702, the state name 703, the start date 705, and the outcome 706, information provided from the data provider is stored. Specifically, the data managing section 113 stores, in columns, data provided from the data providing system 120.

In the target episode number 704, an identification number of a target episode set by the provider of the healthcare information service is stored. In the cost 707 and the conformity 708, a result of calculation processing explained below is stored. Note that, when a state name corresponding to the target episode information 212 is absent in the target episode information 212, the target episode number 704 is a null value.

Specific contents of respective medical practices included in one episode are stored in the medical practice information 215, the test result information 216, and the prescription information 217 explained below.

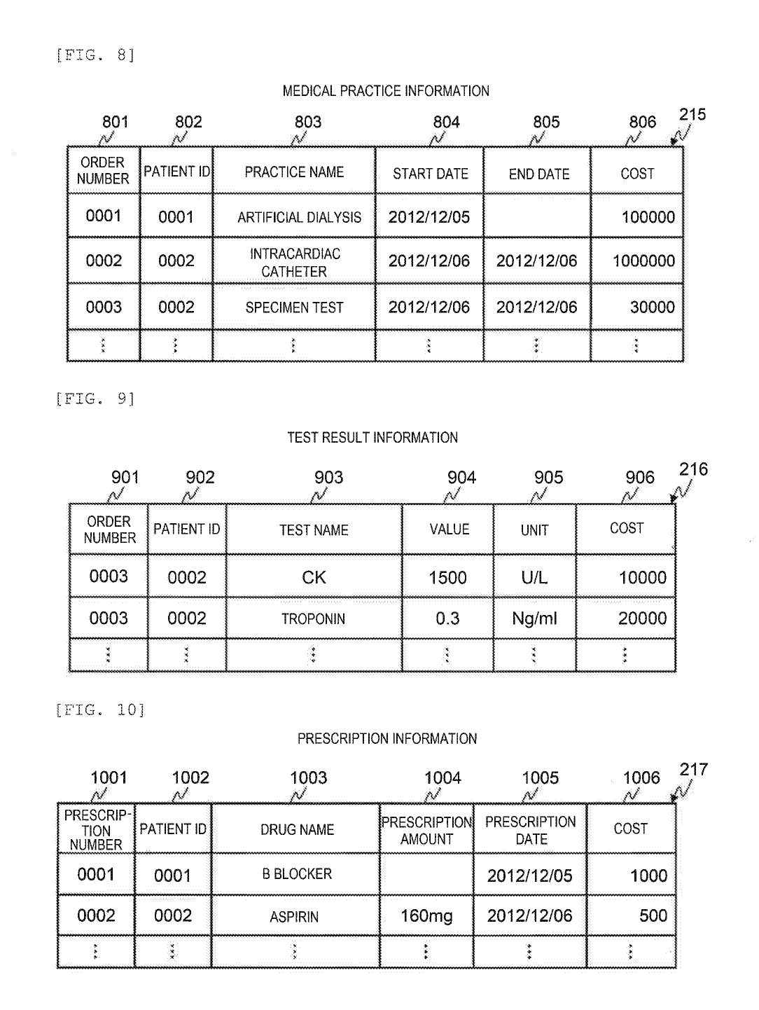

FIG. 8 is an explanatory diagram showing an example of the medical practice information 215 in the first embodiment of the present invention.

The medical practice information 215 is information for managing a medical practice performed on a patient. The medical practice information 215 includes an order number 801, a patient ID 802, a practice name 803, a start date 804, an end date 805, and a cost 806.

The order number 801 is an identification number for identifying a record registered in the medical practice information 215. The patient ID 802 is an identifier for identifying the patient who receives the medical practice. The practice name 803 is a name of the medical practice performed on the patient corresponding to the patient ID 802. In the practice name 803, names concerning the medical practice such as test, treatment, and surgical operation are stored. The start date 804 is a start date of the medical practice. The end date 805 is an end date of the medical practice. The cost 806 is a cost concerning the medical practice.

The medical practice information 215 is generated on the basis of data provided to the data managing section 113 from the data providing system 120. Specifically, the data managing section 113 receives data from the computer 122 of the hospital 121 and stores the received data in the medical practice information 215.

FIG. 9 is an explanatory diagram showing an example of the test result information 216 in the first embodiment of the present invention.

The test result information 216 is a table for managing a result corresponding to a record, the practice name 803 of which is “specimen test”, among records registered in the medical practice information 215. The test result information 216 includes an order number 901, a patient ID 902, a test name 903, a value 904, a unit 905, and a cost 906.

The order number 901 is an identification number for identifying a record of the medical practice information 215. Consequently, it is possible to specify to which record a result of the specimen test corresponds. The patient ID 902 is an identifier for identifying a patient. The test name 903 is a name of the test. The value 904 is a numerical value indicating a result of the test corresponding to the test name 903. The unit 905 is a value of an item in the test. The cost 906 is a cost related to the test corresponding to the test name 903.

When a plurality of tests are performed in one specimen test, a plurality of records, the order number 901 of which is the same, are present in the test result information 216. In FIG. 9, two records, the order number 901 of which is the same, are present.

The test result information 216 is generated on the basis of data provided to the data managing section 113 from the data providing system 120. Specifically, the data managing section 113 receives data from the computer 122 of the hospital 121 and stores the received data in the test result information 216.

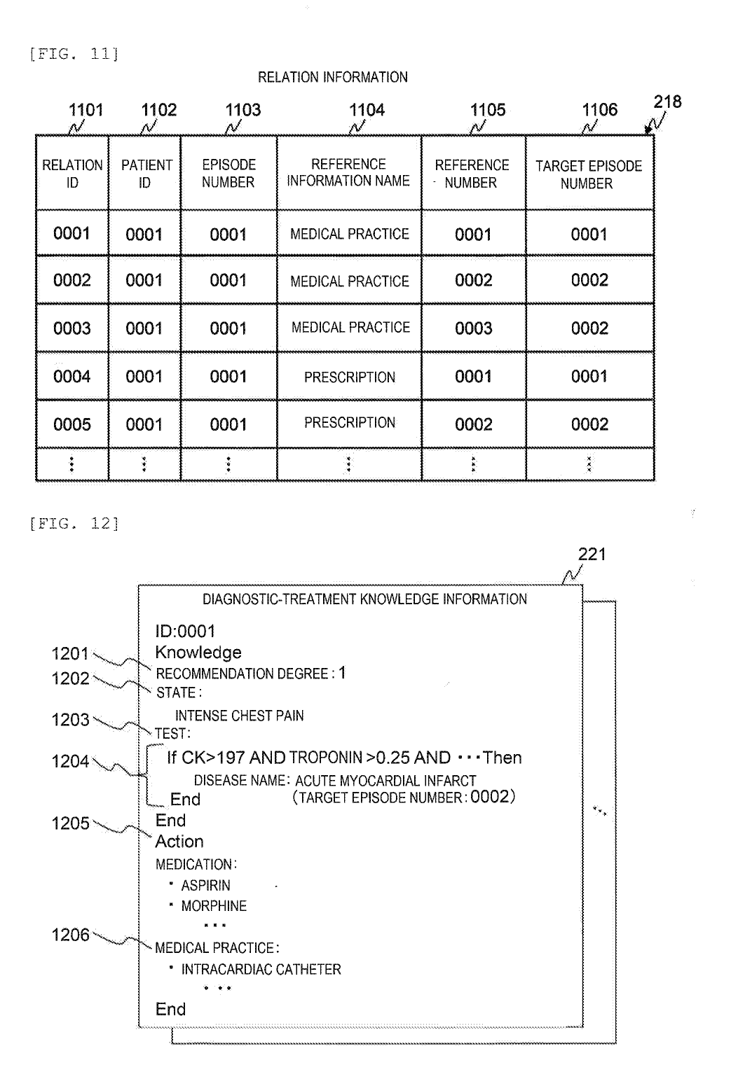

FIG. 10 is an explanatory diagram showing an example of the prescription information 217 in the first embodiment of the present invention.

The prescription information 217 is information for managing contents of a drug prescribed for a patient. The prescription information 217 includes a prescription number 1001, a patient ID 1002, a drug name 1003, a prescription amount 1004, a prescription date 1005, and a cost 1006.

The prescription number 1001 is an identification number for identifying a record registered in the prescription information 217. The patient ID 1002 is an identifier for identifying the patient for whom the drug is prescribed. The drug name 1003 is a name of the drug prescribed for the patient corresponding to the patient ID 1002. The prescription amount 1004 is an amount of the drug corresponding to the drug name 1003. The prescription date 1005 is a date and time when the drug corresponding to the drug name 1003 is prescribed. The cost 1006 is a cost related to the prescription of the drug.

The prescription information 217 is generated on the basis of data provided to the data managing section 113 from the data providing system 120. Specifically, the data managing section 113 receives data from the computer 122 of the hospital 121 and stores the received data in the prescription information 217.

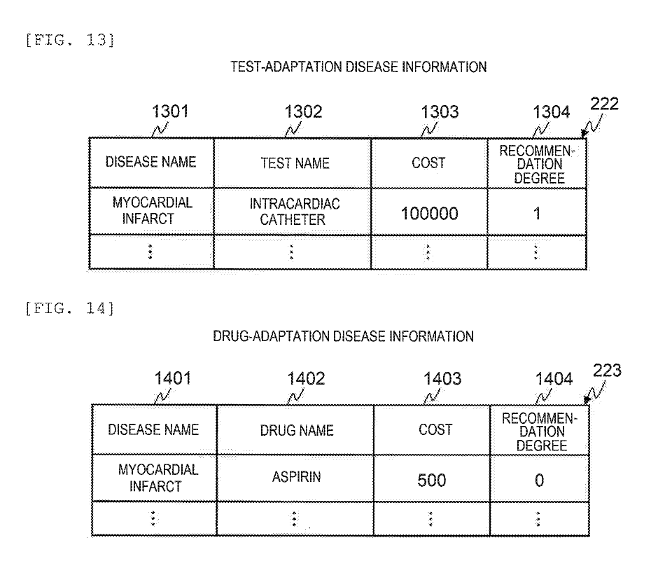

FIG. 11 is an explanatory diagram showing an example of the relation information 218 in the first embodiment of the present invention.

In the medical practice information 215, the test result information 216, and the prescription information 217, records concerning a medical practice performed on a certain patient are stored. However, only from the information, it is impossible to specify which episode the medical practice is related to. Therefore, in the healthcare information DB 114, the relation information 218 is stored as information indicating a relation between the episode and the medical practice.

The relation information 218 is information for managing a medical practice performed on an episode. The relation information 218 includes a relation ID 1101, a patient ID 1102, an episode number 1103, a reference information name 1104, a reference number 1105, and a target episode number 1106.

The relation ID 1101 is an identifier for identifying a record registered in the relation information 218. The patient ID 1102 is an identifier for identifying a patient. The episode number 1103 is an identification number for identifying an episode. As explained below, the episode information 214 is referred to on the basis of the episode number 1103.

The reference information name 1104 is a name of information referred to. A name of the medical practice information 215 or the prescription information 217 is stored in the reference information name 1104. The reference number 1105 is an identification number of a record referred to in the information corresponding to the reference information name 1104. The target episode number 1106 is an identification number of a designated target episode.

When referring to the medical practice information 215, the cost-adjustment-coefficient calculating section 111 refers to the order number 801 of the medical practice information 215 on the basis of the reference number 1105. When referring to the prescription information 217, the cost-adjustment-coefficient calculating section 111 refers to the prescription number 1001 of the prescription information 217 on the basis of the reference number 1105.

FIG. 12 is an explanatory diagram showing an example of the diagnostic-treatment knowledge information 221 in the first embodiment of the present invention.

In the example shown in FIG. 12, the diagnostic-treatment knowledge information 221 has a file structure and is configured from a plurality of items. Specifically, the diagnostic-treatment knowledge information 221 is configured from a plurality of items such as an item indicating a state of a symptom of a patient (a section 1202), an item indicating a test usually performed on the state of the patient and a disease name determined from a test result (a section 1203), an item indicating medication (a medication name) usually administered for the state of the patient (a section 1205), and an item indicating a medical practice (a medical practice name) usually performed on the state of the patient (a section 1206).

The section 1203 includes an item indicating a condition for determining the disease name from the test result (a section 1204).

The diagnostic-treatment knowledge information 221 includes an item indicating a recommendation degree concerning diagnostic treatment corresponding to the diagnostic-treatment knowledge information 221 (a section 1201). In this embodiment, a natural number is set in the recommendation degree. “1” is the highest recommendation degree. The recommendation degree decreases in order from “1”.

In the example shown in FIG. 12, “intense chest pain” is registered in the section 1202 as the state of the patient, “aspirin” and “morphine” are registered in the section 1205 as the medication, and “intracardiac catheter” is registered in the section 1206 as the medical practice. “CK>197, troponin>0.25” is registered in the section 1204 as a condition.

Information registered as the diagnostic-treatment knowledge information 221 is knowledge serving as a theory widely recognized in the medical field. The provider of the healthcare information service stores the knowledge explained above for various symptoms in the medical-knowledge management DB 115 in advance by operating, for example, the management terminal 106.

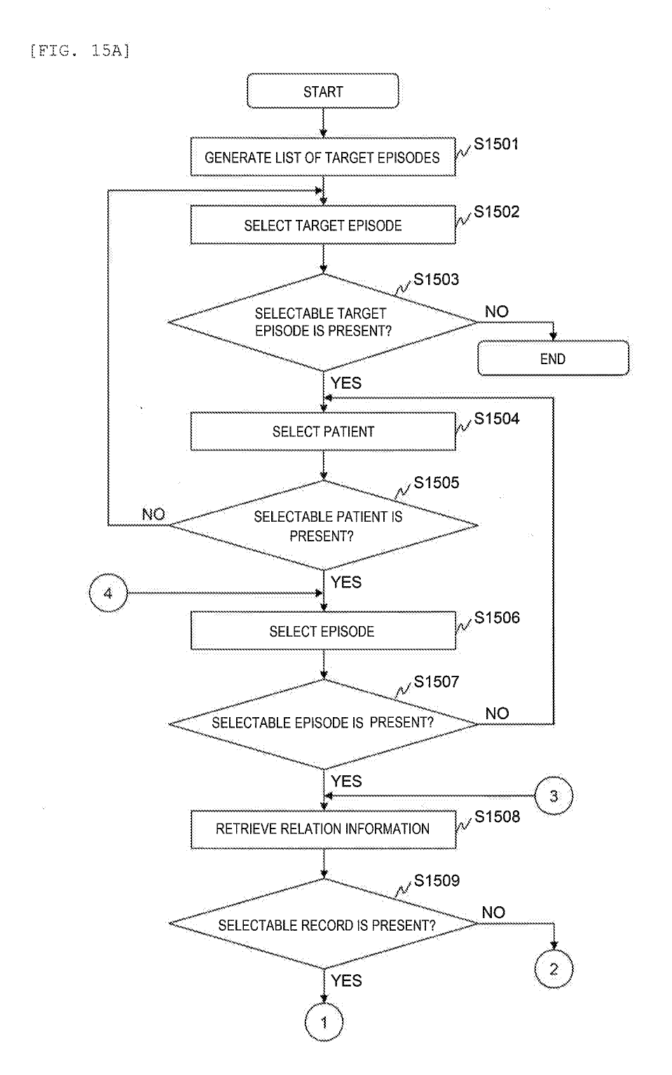

FIG. 13 is an explanatory diagram showing an example of the test-adaptation disease information 222 in the first embodiment of the present invention.

The test-adaptation disease information 222 is information for managing adaptation diseases of tests. The test-adaptation disease information 222 includes a disease name 1301, a test name 1302, a cost 1303, and a recommendation degree 1304.

The disease name 1301 is a disease name. The test name 1302 is a name of a test adapted to the disease name corresponding to the disease name 1301. A certain test being adapted to a certain disease means that implementation of the test has appropriateness when a disease corresponding to the disease name 1301 is suspected. The cost 1303 is a cost concerning the test corresponding to the test name 1302. The recommendation degree 1304 is priority order of a test recommended for the disease corresponding to the disease name 1301.

In this embodiment, “0” or a natural number is stored in the recommendation degree 1304. “1” is the highest recommendation degree. When “0” is stored in the recommendation degree 1304, this indicates that the test is a test for which a recommendation degree is not determined yet or a test for which other information such as a test value is necessary in order to determine a recommendation degree.

Like the diagnostic-treatment knowledge information 221, the provider of the healthcare information service stores the test-adaptation disease information 222 in the medical-knowledge management DB 115 in advance by operating the data managing section 113.

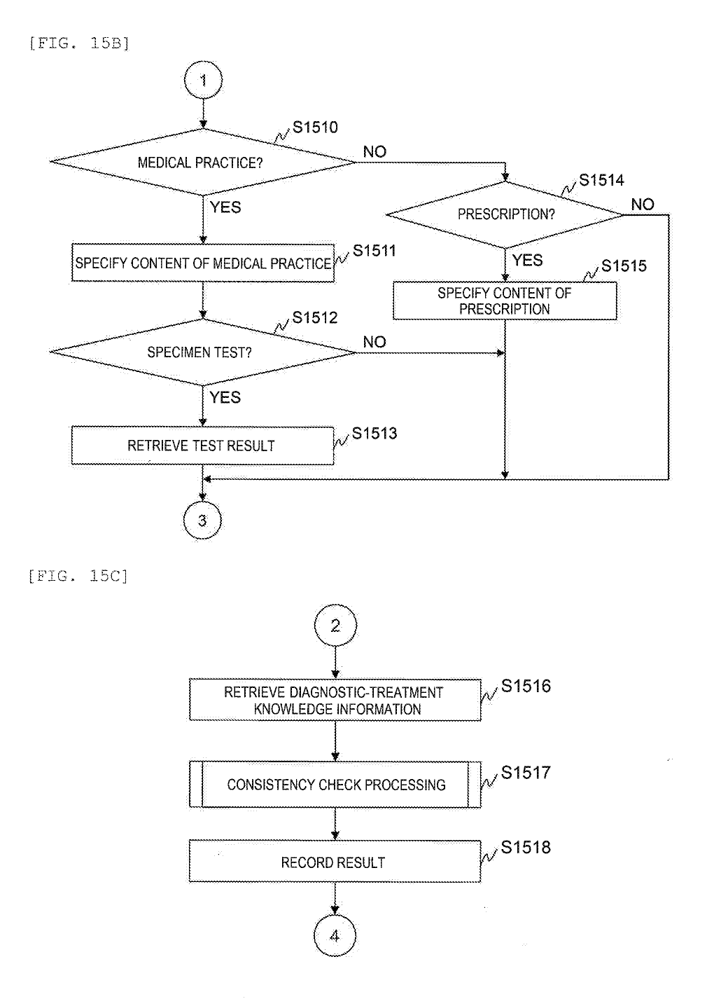

FIG. 14 is an explanatory diagram showing an example of the drug-adaptation disease information 223 in the first embodiment of the present invention.

The drug-adaptation disease information 223 is information for managing adaptation diseases of drugs. The drug-adaptation disease information 223 includes a disease name 1401, a drug name 1402, a cost 1403, and a recommendation degree 1404.

The disease name 1401 is a disease name. The drug name 1402 is a name of a drug adapted to a disease corresponding to the disease name 1401. A certain drug being adapted to a certain disease means that prescription of the drug has appropriateness when the disease corresponding to the disease name 1401 is suspected. The cost 1403 is a cost concerning the drug corresponding to the drug name 1402. The recommendation degree 1404 is priority order of the drug recommended for the disease corresponding to the disease name 1401.

In this embodiment, “0” or a natural number is stored in the recommendation degree 1404. “1” is the highest recommendation degree. When “0” is stored in the recommendation degree 1404, this indicates that the drug is a drug for which a recommendation degree is not determined yet or a drug for which other information such as a test value is necessary in order to determine a recommendation degree.

Like the diagnostic-treatment knowledge information 221, the provider of the healthcare information service stores the drug-adaptation disease information 223 in the medical-knowledge management DB 115 in advance by operating the data managing section 113.

In the present invention, the quality of diagnostic treatment performed in the hospital 121 is evaluated using the diagnostic-treatment knowledge information 221, the test-adaptation disease information 222, and the drug-adaptation disease information 223. That is, the quality of the diagnostic treatment is evaluated according to a degree of coincidence of knowledge registered in the diagnostic-treatment knowledge information 221, the test-adaptation disease information 222, and the drug-adaptation disease information 223 and the diagnostic treatment.

More specifically, the cost-adjustment-coefficient calculating section 111 performs evaluation in two stages using the information explained above. The cost-adjustment-coefficient calculating section 111 compares the knowledge registered in the diagnostic-treatment knowledge information 221 and the diagnostic treatment to calculate first conformity and compares the knowledge registered in the test-adaptation disease information 222 and the drug-adaptation disease information 223 and the diagnostic treatment to calculate second conformity and third conformity.

In the case of the diagnostic treatment well coinciding with the knowledge registered in the diagnostic-treatment knowledge information 221, a value of the first conformity is large. That is, it is evaluated that the quality of the diagnostic treatment is high.

However, the knowledge registered in the diagnostic-treatment knowledge information 221 is detailed information. Therefore, it is less likely that the knowledge completely coincides with the diagnostic treatment performed in the hospital 121. It is also likely that the quality of the diagnostic treatment cannot be correctly evaluated. Therefore, the cost-adjustment-coefficient calculating section 111 calculates the second conformity and the third conformity using the test-adaptation disease information 222 and the drug-adaptation disease information 223 in which information rougher than the information registered in the diagnostic-treatment knowledge information 221 is registered.

The information used in this embodiment is explained with reference to FIG. 4 to FIG. 14. However, the present invention is not limited to the data format. For example, a plurality of kinds of information may be collectively stored as one kind of information or one kind of information may be stored as information divided into two or more.

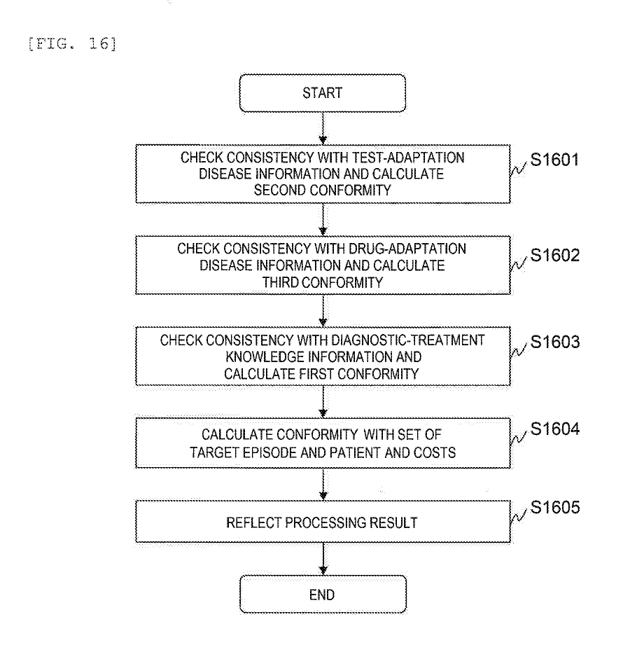

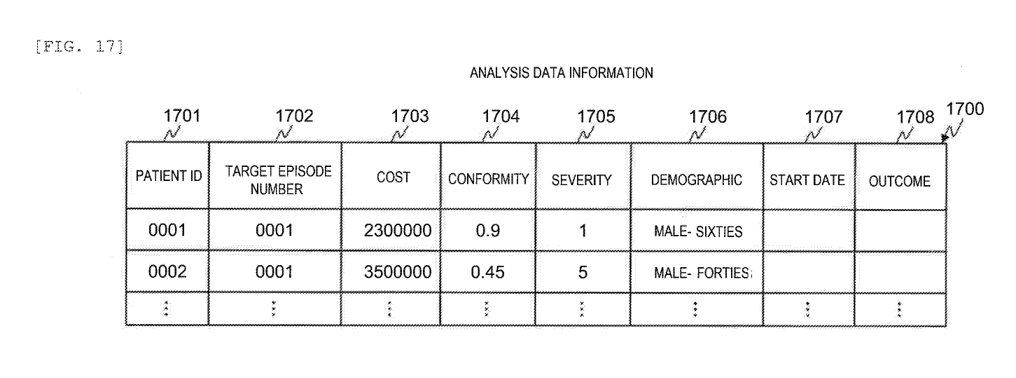

FIG. 15A, FIG. 15B, and FIG. 15C are flowcharts for explaining processing executed by the conformity/cost calculating section 201 of the cost-adjustment-coefficient calculating section 111 in the first embodiment of the present invention.

The server 101 starts processing cyclically or when receiving an instruction of the provider of the healthcare information service. The server 101 invokes the cost-adjustment-coefficient calculating section 111 and instructs a start of the processing. When receiving the start instruction for the processing, the cost-adjustment-coefficient calculating section 111 invokes the conformity/cost calculating section 201 and instructs a start of the processing. When being invoked by the cost-adjustment-coefficient calculating section 111, the conformity/cost calculating section 201 starts the processing explained below.

The conformity/cost calculating section 201 acquires all records registered in the target episode information 212 and stores the records on the memory 103 as a list of target episodes (step S1501). The conformity/cost calculating section 201 generates analysis data information 1700 shown in FIG. 16 on the memory 103.

The conformity/cost calculating section 201 selects one target episode set as a processing target out of the list of the target episodes (step S1502). It is assumed that the target episode is selected in order out of the records on the list. The conformity/cost calculating section 201 adds a new record to the analysis data information 1700 and registers an identification number (the target episode number 502) of the selected target episode in a target episode number 1702 of the added record.

The conformity/cost calculating section 201 determines whether the target episode set as the processing target is present (step S1503). That is, it is determined whether the processing has been completed for all the target episodes.

If it is determined that the target episode set as the processing target is absent, that is, if it is determined that the processing is completed for all the target episodes, the conformity/cost calculating section 201 ends the processing.

If it is determined that the target episode set as the processing target is present, that is, if it is determined that the processing has not been completed for all the target episodes, the conformity/cost calculating section 201 selects a patent set as a processing target (step S1504). Specifically, the conformity/cost calculating section 201 selects one record out of the patient information 213. It is assumed that the record is selected in order out of the records on the patient information 213. The conformity/cost calculating section 201 registers an identifier (the patient ID 601) of the selected patient in a patient ID 1701 of the new record of the analysis data information 1700.

The conformity/cost calculating section 201 determines whether the patient set as the processing target is present (step S1505). That is, it is determined whether the processing of all the patients for the target episode selected in step S1502 has been completed. The conformity/cost calculating section 201 repeatedly executes the processing from step S1506 to step S1518 for each of combinations of the target episodes and the patients.

If it is determined that the patient set as the processing target is absent, that is, the processing of all the patients for the target episode selected in step S1502 has been completed, the conformity/cost calculating section 201 returns to step S1502 and executes the same processing thereafter.

If it is determined that the patient set as the processing target is present, that is, the processing of all the patients for the target episode selected in step S1502 has not been completed, the conformity/cost calculating section 201 retrieves all episodes of the selected patient and selects a processing target episode out of the retrieved episodes (step S1506).

Specifically, the conformity/cost calculating section 201 refers to the episode information 214 and retrieves all records, the patient ID 702 of which coincides with the patient ID 601 of the record selected out of the patient information 213 in step S1504 and the target episode number 704 of which coincides with the target episode number 502 of the record selected out of the list of the target episodes in step S1502. The conformity/cost calculating section 201 selects one processing target record out of the retrieved records.

The conformity/cost calculating section 201 determines whether a selectable episode is present (step S1507). That is, it is determined whether the processing has been completed for all the episodes of the patient selected in step S1504.

When it is determined that the selectable episode is absent, that is, the processing has been completed for all the episodes of the patient selected in step S1504, the conformity/cost calculating section 201 returns to step S1504 and executes the same processing.

When it is determined that the selectable episode is present, that is, the processing has not been completed for all the episodes of the patient selected in step S1504, the conformity/cost calculating section 201 checks, for the selected episode of the selected patient, consistency with the medical-knowledge management DB 115 (step S1508 to step S1518).

First, the conformity/cost calculating section 201 refers to the relation information 218, retrieves all records related to the episode selected in step S1506, and selects a processing target record out of the retrieved records (step S1508).

Specifically, the conformity/cost calculating section 201 retrieves all records, the episode number 1103 of which coincides with the episode number 701 of the record selected in step S1506. The conformity/cost calculating section 201 selects one processing target record out of retrieved records.

The conformity/cost calculating section 201 determines whether a selectable record is present in the relation information 218 (step S1509). That is, it is determined whether the processing has been completed for all the records retrieved from the relation information 218.

If it is determined that the selectable record is absent in the relation information 218, that is, if it is determined that the processing has been completed for all the records retrieved from the relation information 218, the conformity/cost calculating section 201 proceeds to step S1516.

If it is determined that the selectable record is present in the relation information 218, that is, if it is determined that the processing has not been completed for all the records retrieved from the relation information 218, the conformity/cost calculating section 201 determines whether the reference information name 1104 of the record selected in step S1508 is “medical practice” (step S1510).

If it is determined that the reference information name 1104 of the record selected out of the relation information 218 is the “medical practice”, the conformity/cost calculating section 201 specifies content of the medical practice (step S1511).

Specifically, the conformity/cost calculating section 201 refers to the medical practice information 215 and retrieves a record, the order number 801 of which coincides with the reference number 1105 of the record selected out of the relation information 218. The conformity/cost calculating section 201 acquires a name of the medical practice from the practice name 803 of the retrieved record. At this point, the conformity/cost calculating section 201 acquires a value from a cost 807 of the retrieved record.

Subsequently, the conformity/cost calculating section 201 determines whether the practice name 803 of the record retrieved in step S1511 is “specimen test” (step S1512).

If it is determined that the practice name 803 of the retrieved record is not the “specimen test”, the conformity/cost calculating section 201 returns to step S1508 and executes the same processing.

If it is determined that the practice name 803 of the retrieved record is the “specimen test”, the conformity/cost calculating section 201 retrieves a test result from the test result information 216 (step S1513). Thereafter, the conformity/cost calculating section 201 returns to step S1508 and executes the same processing.

Specifically, the conformity/cost calculating section 201 refers to the test result information 216 and retrieves a record, the order number 901 of which coincides with the reference number 1105 of the record selected out of the relation information 218. The conformity/cost calculating section 201 acquires a numerical value and a unit of a result of the test from the value 904 and the unit 905 of the retrieved record and acquires a cost from the cost 906.

If it is determined in step S1510 that the reference information name 1104 of the record selected out of the relation information 218 is not the “medical practice”, the conformity/cost calculating section 201 determines whether the reference information name 1104 of the record is “prescription” (step S1514).

If it is determined that the reference information name 1104 of the record selected out of the relation information 218 is not the “prescription”, that is, the reference information name 1104 of the record is neither the “medical practice” nor the “prescription”, the conformity/cost calculating section 201 returns to step S1508 and executes the same processing.

If it is determined that the reference information name 1104 of the record selected out of the relation information 218 is the “prescription”, the conformity/cost calculating section 201 specifies content of the prescription (step S1515). Thereafter, the conformity/cost calculating section 201 returns to step S1508 and executes the same processing.

Specifically, the conformity/cost calculating section 201 refers to the prescription information 217 and retrieves a record, the prescription number 1001 of which coincides with the reference number 1105 of the record selected out of the relation information 218. The conformity/cost calculating section 201 acquires a name of the drug from the drug name 1003 of the retrieved record and acquires a cost from the cost 1006.

Note that a set of the medical practice and the cost acquired from the practice name 803 and the cost 807 in step S1511, a set of the value, the unit, and the cost acquired from the value 904, the unit 905, and the cost 906 in step S1513, and a set of the drug name and the cost acquired from the drug name 1003 and the cost 1006 in step S1515 are stored in association with a set of a target episode number and a patient ID.

If it is determined in step S1509 that the selectable record is absent in the relation information 218, the conformity/cost calculating section 201 retrieves the diagnostic-treatment knowledge information 221 corresponding to the target episode (step S1516). Thereafter, the conformity/cost calculating section 201 proceeds to step S1517.

Specifically, the conformity/cost calculating section 201 retrieves the diagnostic-treatment knowledge information 221, the target episode number included in the section 1204 of each of the diagnostic-treatment knowledge information 221 of which coincides with the target episode number 502 of the target episode selected in step S1502.

The conformity/cost calculating section 201 executes conformity check processing using the diagnostic-treatment knowledge information 221, the test-adaptation disease information 222, and the drug-adaptation disease information 223 retrieved in step S1514 (step S1517).

In the conformity check processing, the conformity/cost calculating section 201 checks a degree of coincidence (a matching degree) of a medical care performed on a certain state name, a test result, a prescribed drug, and the like with the information concerning the medical knowledge (conditions concerning medicine) registered in advance shown in FIG. 12 to FIG. 14. The conformity/cost calculating section 201 collects costs acquired concerning a medical practice, a test, and prescription. Details of the consistency check processing are explained below with reference to FIG. 16.

The conformity/cost calculating section 201 records a calculation result of the consistency check processing (step S1518). Thereafter, the conformity/cost calculating section 201 returns to step S1506 and executes the same processing.

FIG. 16 is a flowchart for explaining the details of the consistency check processing in the first embodiment of the present invention.

The conformity/cost calculating section 201 calculates the second conformity by checking consistency with the test-adaptation disease information 222 (step S1601). Specifically, processing explained below is executed.

The conformity/cost calculating section 201 acquires a state name from the state name 703 of a record corresponding to the episode selected in step S1506. The conformity/cost calculating section 201 retrieves a record, the disease name 1301 of which coincides with the acquired state name and the test name 1302 of which coincides with the practice name acquired in step S1511.

When a record satisfying the conditions is present, the conformity/cost calculating section 201 determines that there is consistency with information registered in the test-adaptation disease information 222. On the other hand, when the record satisfying the conditions is absent, the conformity/cost calculating section 201 determines that there is no consistency with the information registered in the test-adaptation disease information 222.

The conformity/cost calculating section 201 calculates the second conformity on the basis of conformity concerning the consistency and weight concerning the recommendation degree 1304 of the record satisfying the conditions.

In this embodiment, when there is consistency with the information registered in the test-adaptation disease information 222, the conformity concerning the consistency is “0.3” and, when there is no consistency with the information registered in the test-adaptation disease information 222, the conformity concerning the consistency is “0”. When a value of the recommendation degree 1304 is “1”, the weight concerning the recommendation degree 1304 is “1”. When the value of the recommendation degree 1304 is “2”, the weight concerning the recommendation degree 1304 is “0.8”. When the value of the recommendation degree 1304 is “3”, the weight concerning the recommendation degree 1304 is “0.5”. When the value of the recommendation degree 1304 is “0”, the weight concerning the recommendation degree 1304 is “0.3”. The conformity/cost calculating section 201 calculates the second conformity by multiplying together the conformity concerning the consistency and the weight concerning the recommendation degree 1304.

When a plurality of sets of practice names and costs associated with a combination of a target episode number and a patient ID are present, the conformity/cost calculating section 201 selects one set of a practice name and a cost and repeatedly executes the processing on the selected set.

The processing in step S1601 is as explained above.

Subsequently, the conformity/cost calculating section 201 calculates the third conformity by checking consistency with the drug-adaptation disease information 223 (step S1602). Specifically, processing explained below is executed.

The conformity/cost calculating section 201 acquires a state name from the state name 703 of a record corresponding to the episode selected in step S1506. The conformity/cost calculating section 201 retrieves a record, the disease name 1401 of which coincides with the acquired state name and the drug name 1402 of which coincides with the drug name acquired in step S1515.

When a record satisfying the conditions is present, the conformity/cost calculating section 201 determines whether there is consistency with information registered in the drug-adaptation disease information 223. On the other hand, when the record satisfying the conditions is absent, the conformity/cost calculating section 201 determines that there is no consistency with the information registered in the drug-adaptation disease information 223.

The conformity/cost calculating section 201 calculates the third conformity on the basis of the conformity concerning the consistency and weight concerning the recommendation degree 1404 of the record satisfying the conditions.

In this embodiment, when there is consistency with the information registered in the drug-adaptation disease information 223, the conformity concerning the consistency is “0.3” and, when there is no consistency with the information registered in the drug-adaptation disease information 223, the conformity concerning the consistency is “0”. When a value of the recommendation degree 1404 is “1”, the weight concerning the recommendation degree 1404 is “1”. When the value of the recommendation degree 1404 is “2”, the weight concerning the recommendation degree 1404 is “0.8”. When the value of the recommendation degree 1404 is “3”, the weight concerning the recommendation degree 1404 is “0.5”. When the value of the recommendation degree 1404 is “0”, the weight concerning the recommendation degree 1404 is “0.3”. The conformity/cost calculating section 201 calculates the third conformity by multiplying together the conformity concerning the consistency and the weight concerning the recommendation degree 1404.

When a plurality of sets of drug names and costs associated with a combination of a target episode number and a patient ID are present, the conformity/cost calculating section 201 selects one set of a drug name and a cost and repeatedly executes the processing on the selected set.

The processing in step S1602 is as explained above.

Subsequently, the conformity/cost calculating section 201 calculates the first conformity by checking consistency with the diagnostic-treatment knowledge information 221 retrieved in step S1514 (step S1603). Specifically, processing explained below is executed.

The conformity/cost calculating section 201 refers to the section 1205 on the basis of the drug name acquired in step S1515 and determines whether the drug name is consistent with the drug name described in the section 1205. The conformity/cost calculating section 201 refers to the section 1206 on the basis of the practice name acquired in step S1511 and determines whether the practice name is consistent with the practice name described in the section 1206. Further, the conformity/cost calculating section 201 refers to the section 1204 on the basis of the numerical value and the unit of the result of the test acquired in step S1513 and determines whether the numerical value and the unit are consistent with the conditions described in the section 1204.

The conformity/cost calculating section 201 determines consistency with the diagnostic-treatment knowledge information 221 on the basis of determination results of the three kinds of consistency. The conformity/cost calculating section 201 calculates the first conformity on the basis of the conformity concerning the consistency and weight corresponding to the recommendation degree of the section 1201.

In this embodiment, when there is complete consistency with the diagnostic-treatment knowledge information 221, the conformity concerning the consistency is “0.4”. When there is partial consistency with the diagnostic-treatment knowledge information 221, the conformity concerning the consistency is “0.3”. When there is no consistency with the diagnostic-treatment knowledge information 221, the conformity concerning the consistency is “0.3”. When a value of a recommendation degree is “1”, weight concerning the recommendation degree is “1”. When the value of the recommendation degree is “2”, the weight concerning the recommendation degree is “0.8”. When the value of the recommendation degree is “3”, the weight concerning the recommendation degree is “0.5”. When the value of the recommendation degree is “0”, the weight concerning the recommendation degree is “0.3”. The conformity/cost calculating section 201 calculates the first conformity by multiplying together the conformity concerning the consistency and the weight concerning the recommendation degree.

The conformity/cost calculating section 201 calculates conformity with a combination of a target episode and a patient and costs (step S1604). The conformity/cost calculating section 201 reflects a processing result (step S1605) and ends the processing. Specifically, processing explained below is executed.

The conformity/cost calculating section 201 calculates a total value of the first conformity, the second conformity, and the third conformity. The conformity/cost calculating section 201 calculates a total value of the costs acquired in step S1511, step S1512, and step S1515. The conformity/cost calculating section 201 stores the calculated total value of the costs in a cost 1703 of the record added to the analysis data information 1700 and stores the total value of the three kinds of conformity in conformity 1704 of the record.

The conformity/cost calculating section 201 refers to the episode information 214 and retrieves a record, the target episode number 704 of which coincides with a number of the target episode selected in step S1502 and the episode number 701 of which coincides with a number of the episode selected in step S1506. The conformity/cost calculating section 201 stores the total value of the costs in the cost 707 of the retrieved record and stores the total value of the three kinds of conformity in the conformity 708 of the record.

Note that the value of the conformity can also be determined and changed on the basis of an analysis result of data in the past. In the consistency check processing, the conformity is calculated for each of the diagnostic-treatment knowledge information 221, the test-adaptation disease information 222, and the drug-adaptation disease information 223. However, the present invention is not limited to this. For example, the consistency check processing may be processing performed using only the diagnostic-treatment knowledge information 221 or may be processing performed using only the test-adaptation disease information 222 and the drug-adaptation disease information 223.

The consistency check processing is explained using a specific example.

In the following explanation, in step S1502, a record, the target episode number 502 of which is “0002” and the state name 503 of which is “myocardial infarct”, shown in FIG. 5 is selected. In step S1504, a record, the patient ID 601 of which is “0001”, is selected.

In this case, in step S1506, a second record from the top of the episode information 214 shown in FIG. 7 is selected. In step S1508, three records, the relation ID 1101 of which is “0002”, “0003”, and “0005”, are retrieved. That is, two records, the reference information name 1104 of which is “medical practice”, and one record, the reference information name 1104 of which is “prescription”, are retrieved. The processing from step S1510 to step S1515 is executed for the respective records.

In the case of a record, the relation ID 1101 of which is “0002”, the conformity/cost calculating section 201 refers to a record, the order number 801 of which is “0002”, of the medical practice information 215 and acquires a practice name “intracardiac catheter” and a cost “1000000”.

In the case of a record, the relation ID 1101 of which is “0003”, the conformity/cost calculating section 201 refers to a record, the order number 801 of which is “0003”, of the medical practice information 215 and further refers to a record, the order number 901 of which is “003”, of the test result information 216. Consequently, the conformity/cost calculating section 201 acquires a test name “CK”, a test result “1500 U/L” and a cost “10000” and a test name “troponin”, a test result “0.3 Ng/ml”, and a cost “20000”.

In the case of a record, the relation ID 1101 of which is “0005”, the conformity/cost calculating section 201 refers to a record, the prescription number 1001 of which is “0002”, of the prescription information 217 and acquires a drug name “aspirin”, a prescription amount “160 mg”, and a cost “500”.

When the contents explained above are organized, it is seen that the “intracardiac catheter” and the “specimen test” were performed as the medical practice for the “myocardial infarct”, the episode number of which is “0001” and the target episode number of which is “0002”, the two tests of the “CK” and the “troponin” were performed in the specimen test, the test result of the CK was “1500 U/L”, and the test result of the troponin was “0.3 Ng/ml”, and the “aspirin” was administered “160 mg” as the prescription for the “myocardial infarct”.

The consistency check processing is explained on the basis of the retrieval result explained above.

In step S1601, processing is executed on a record, the relation ID 1101 of which is “0002”. In this case, a disease name and a practice name respectively coincide with the disease name 1301 and the test name 1302 of a first record of the test-adaptation disease information 222. Therefore, contents of the record, the relation ID 1101 of which is “0002”, are consistent with the contents of the first record of the test-adaptation disease information 222. The recommendation degree 1304 of a first record of the test-adaptation disease information 223 is “1”. Therefore, the second conformity is calculated as “0.3×1”.

In step S1602, processing is executed on a record, the relation ID 1101 of which is “0005”. In this case, a disease name and a drug name respectively coincide with the disease name 1401 and the drug name 1402 of a first record of the drug-adaptation disease information 223. Therefore, contents of the record, the relation ID 1101 of which is “0005”, are consistent with the contents of the first record of the drug-adaptation disease information 223. The recommendation degree 1404 of the first record of the drug-adaptation disease information 223 is “0”. Therefore, the third conformity is calculated as “0.3×0.3”.

In step S1603, consistency with the medical practice information 215 is checked using the records, the relation ID 1101 of which is “0002”, “0003”, and “0005”. In this case, in the section 1205, although the drug “aspirin” coincides with the medical practice information 215, the “morphine” is not prescribed. Therefore, a part of the records coincides with the medical practice information 215. In section 1206, the medical practice “intracardiac catheter” coincides with the medical practice information 215. The conditions of the section 1204 are “CK>197” and “troponin>0.25”. Both the test results satisfy the two conditions. Therefore, it is determined that the records coincide with the conditions. In the section 1201, “1” is set as the recommendation degree. Therefore, the first conformity is calculated as “0.3×1”.

In step S1604, the total value of the three kinds of conformity is calculated as “0.69” and the total value of the costs is calculated as “1031500”.

In step S1605, “1031500” is stored in the cost 707 of a record, the episode number 701 of which is “0001” and the target episode number 704 of which is “0002”, and “0.69” is stored in the conformity 708 of the record.

The specific example of the consistency check processing is as explained above. According to the consistency check processing, in a medical institution such as a hospital, it is possible to represent, as a numerical value (conformity), a degree of recommended diagnostic treatment performed on a disease. As the conformity is higher, it is possible to evaluate that the quality of the diagnostic treatment is higher. As explained below, by calculating adjusted costs using the conformity, it is possible to adjust costs taking into account the quality of the diagnostic treatment.

Processing executed by the severity identifying section 202 is explained.

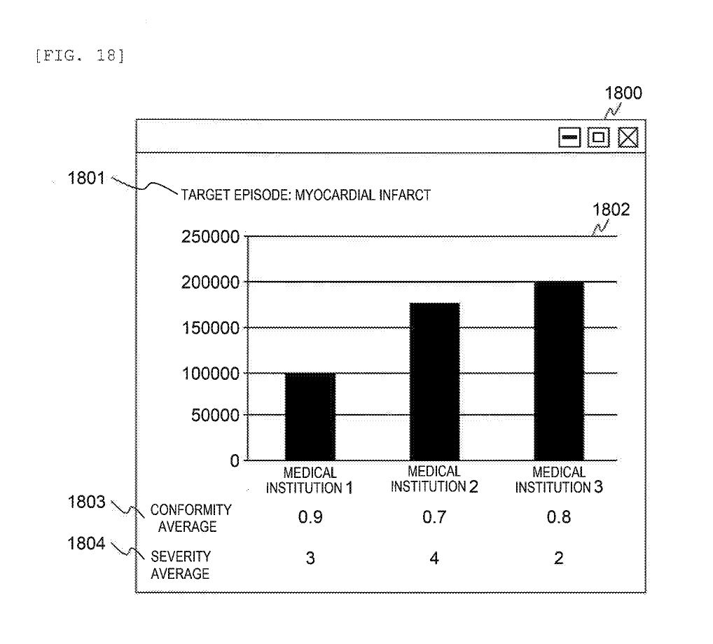

After the processing of the conformity/cost calculating section 201 ends, the cost-adjustment-coefficient calculating section 111 invokes the severity identifying section 202 and instructs a start of processing. At this point, the severity identifying section 202 generates analysis data information 1700 shown in FIG. 17.

FIG. 17 is an explanatory diagram showing an example of the analysis data information 1700 in the first embodiment of the present invention.

The analysis data information 1700 is information for managing data used in calculating a cost adjustment coefficient and adjusted costs. The analysis data information 1700 includes a patient ID 1701, a target episode number 1702, a cost 1703, conformity 1704, severity 1705, a demographic 1706, a start date 1707, and an outcome 1708.

The patient ID 1701 is an identifier for identifying a patient. The target episode number 1702 is an identification number for identifying a target episode. The cost 1703 is a total value of costs for a combination of a patient and a target episode. The conformity 1704 is a value indicating consistency with the medical-knowledge management DB 115 for the combination of the patient and the target episode. The severity 1705 is a value indicating severity of the patient. The demographic 1706 is a demographic factor. The start date 1707 is a start date of the target episode. The outcome 1708 is a consequence of the target episode.

Note that, as demographic factors, there are male-teens, male-twenties, male-thirties, male-forties, male-fifties, male-sixties, male-seventies, male-eighties, male-nineties, female-teens, female-twenties, female-thirties, female-forties, female-fifties, female-sixties, female-seventies, female-eighties, and female-nineties. Any one of the eighteen classifications is stored in the demographic 1706.

Occurrence of a complication increases as an age is higher. Therefore, usually, costs are required for diagnostic treatment. On the other hand, depending on a target episode, severity of the target episode changes according to sex and costs for the diagnostic treatment change. The demographic factors are provided to take into account the influence of a generation and sex on costs explained above.

The analysis data information 1700 is as explained above.

The severity identifying section 202 refers to the episode information 214 and selects a record of a processing target episode. The severity identifying section 202 counts the number of records for which a number same as the episode number 701 of the selected record is set. Note that the number of records is the number of complications and comorbidities in the processing target episode. In this embodiment, severity is treated as higher as the number of records is larger.

The severity identifying section 202 refers to the state name 703 of records, the episode number 701 of which is the same, and retrieves, as a representative record, a record corresponding to a main disease name out of the records. The severity identifying section 202 acquires a number, a start date, and an outcome of the target episode from the target episode number 704, the start date 705, and the outcome 706 of the retrieved record.

A method explained below is conceivable as a method of determining whether a type of a record is a main disease name. First, the severity identifying section 202 refers to the target episode information 212 using the target episode number 704 of the records, the episode number 701 of which is the same, as a search condition and retrieves a record, the target episode number 502 of which coincides with the target episode number 704. The severity identifying section 202 determines whether the type 504 of the retrieved record is a “main disease name”.

The severity identifying section 202 adds a new record to the analysis data information 1700 and stores, in the patient ID 1701 of the record of the processing target episode, an identifier registered in the patient ID 702 of the record. The severity identifying section 202 stores the acquired number, start date, and outcome of the target episode in the target episode number 1702, the start date 1707, and the outcome 1708 of the added record. The severity identifying section 202 stores the counted number of records in the severity 1705 of the added record.

The severity identifying section 202 repeatedly executes the processing until all the records of the episode information 214 are processed.

The processing executed by the severity identifying section 202 is as explained above. Processing executed by the demographic-factor identifying section 203 is explained.

The demographic-factor identifying section 203 selects one processing target record out of the analysis data information 1700. The demographic-factor identifying section 203 refers to the patient information 213 and retrieves records, the patient ID 601 of which coincides with an identifier of the patient ID 1701 of the selected record. The demographic-factor identifying section 203 acquires a date of birth and sex of a patient from the date of birth 603 and the sex 604 of the retrieved record.

The demographic-factor identifying section 203 calculates an age of the patient at a processing execution point in time on the basis of the acquired date of birth and classifies the age into a generation to which the patient belongs. In this embodiment, the age is classified into nine generations from teens to nineties. The demographic-factor identifying section 203 stores, in the demographic 1706 of the processing target record, information in which the acquired sex and the classified generation are associated.

The processing executed by the demographic-factor identifying section 203 is as explained above. Processing executed by the conformity/cost totalizing section 204 is explained.

The conformity/cost totalizing section 204 refers to the episode information 214 and selects a record of a processing target episode. At this point, the conformity/cost totalizing section 204 acquires an identifier of a patient from the patient ID 702 of the record of the processing target episode. The conformity/cost totalizing section 204 retrieves all records in which a number same as the episode number 701 of the selected record is set.

The conformity/cost totalizing section 204 acquires costs from the cost 707 of the retrieved records and calculates a total of the costs acquired from the records. The conformity/cost totalizing section 204 acquires conformity from the conformity 708 of the retrieved records and calculates an average of the conformity. The conformity/cost totalizing section 204 retrieves a record corresponding to a main disease name out of the retrieved records using a method same as the method of the severity identifying section 202. The conformity/cost totalizing section 204 acquires an identification number of the target episode from the target episode number 704 of the retrieved record.

The conformity/cost totalizing section 204 refers to the analysis data information 1700 and retrieves a record, the patient ID 1701 of which coincides with the acquired identifier of the patient and the target episode number 1702 of which coincides with the acquired identification number of the target episode. The conformity/cost totalizing section 204 stores the calculated total value of the costs in the cost 1703 of the retrieved record and stores the calculated conformity average in the conformity 1704 of the record.

The processing executed by the conformity/cost totalizing section 204 is as explained above. Processing executed by the regression analysis section 205 is explained.

The regression analysis section 205 refers to the analysis data information 1700 and generates, on the basis of the target episode number 1702, a group of records registered in the analysis data information 1700. For example, a group, the target episode number 1702 of which is “0001”, a group, the target episode number 1702 of which is “0003”, and the like are generated. The regression analysis section 205 sets the number of generated groups to “n” and allocates serial numbers “1” to “n” to the generated groups.

The regression analysis section 205 performs a regression analysis of the following Expression (1), for each of the groups, to thereby calculate coefficients a, b, and c. Note that w(i, k) is given by the following Expression (2).

w(i,k)=aX(i,k)+bZ(i,k)+cU(i,k)+e(i,k) (1)

w(i,k)=ln(Cost(i,k)) (2)

In the Expression (2), Cost(i, k) represents costs of a sample (a record) k included in a group i of a target episode. In the following explanation, the sample k included in the group i of the target episode is also described as (i, k). X(i, k) represents a demographic vector related to (i, k), Z(i, k) represents a severity factor related to (i, k), U(i, k) represents a conformity factor related to (i, k), and e(i, k) represents an error term.

X(i, k) is an eighteen-dimensional vector. Components correspond to the classifications in the demographic factors. For example, when a demographic factor corresponding to the sample k is “male-sixties”, a value of a vector component corresponding to the demographic factor is “1”. Values of the other vector components are “0”. This is seen if the demographic 1706 of a record corresponding to the sample k of the analysis data information 1700 is checked.

Z(i, k) and U(i, k) are scalar values. Values of the severity 1705 and the conformity 1704 of the record corresponding to the sample k are substituted in Z(i, k) and U(i, k).

Specific processing of the regression analysis is as explained below. First, the regression analysis section 205 selects one processing target group out of n groups of target episodes. The regression analysis section 205 refers to the analysis data information 1700 and retrieves a record coinciding with a target episode number corresponding to the group for which the target episode number 1702 is selected. The regression analysis section 205 calculates the coefficients a, b, and c using Expression (1) for the retrieved record. Records included in the groups of the target episodes are identified using the coefficient c.

The processing executed by the regression analysis section 205 is as explained above.

Processing executed by the adjusted-cost calculating section 112 is explained.

After the processing of the cost-adjustment-coefficient calculating section 111 ends, the adjusted-cost calculating section 112 invokes the data-by-medical-institution/episode collecting section 301 and instructs a start of processing.

The data-by-medical-institution/episode collecting section 301 refers to the medical institution information 211 and specifies all medical institutions. Further, the data-by-medical-institution/episode collecting section 301 specifies, for each of the medical institutions, all patients attended by the medical institution. Specifically, the data-by-medical-institution/episode collecting section 301 selects a processing target medical institution, refers to the patient information 213, and retrieves records having the same identifier stored in the medical institution ID 605 and the medical institution ID 401 of a record corresponding to the processing target medical institution. The data-by-medical-institution/episode collecting section 301 generates, on the basis of the retrieved records, a list of identifiers (patient IDs) of the patients attended by the processing target medical institutions.

Subsequently, the data-by-medical-institution/episode collecting section 301 refers to the target episode information 212 and specifies all records of target episodes in which “main disease name” is stored in the type 504.

The data-by-medical-institution/episode collecting section 301 refers to the analysis data information 1700, retrieves, for all the patients attended by the medical institutions, the specified records having the target episodes, and generates a list of the target episodes. Specifically, the data-by-medical-institution/episode collecting section 301 retrieves a record by referring to the patient ID 1701 and the target episode number 1702 using, as retrieval conditions, patient IDs registered in a list of patient IDs of each of the medical institutions and target episode numbers registered in a list of target episodes, the type 504 of which is the “main disease name”.

The adjusted-cost totalizing section 302 totalizes, for each of the medical institutions and for each of the target episodes, the type 504 of which is the “main disease name”, costs for the retrieved record. At this point, the adjusted-cost totalizing section 302 corrects costs using the cost adjustment coefficient calculated by the cost-adjustment-coefficient calculating section 111 and totalizes the costs after the correction. Specifically, processing explained below is executed.

First, the adjusted-cost totalizing section 302 selects a processing target medical institution and further selects a processing target episode in the medical institution. The adjusted-cost totalizing section 302 acquires, from a list of the extracted target episodes, records coinciding with an identification number of the processing target episode. The adjusted-cost totalizing section 302 puts a value of the cost 1703 of the acquired records as L(i, k). In L(i, k), i is a variable for identifying the processing target episode and k is a variable for identifying the record. At this point, the adjusted-cost totalizing section 302 corrects the costs using the following Expression (3).

S(i,k)=Exp(Log(L(i,k))−aX(i,k)−bZ(i,k)−cU(i,k)) (3)

Note that a, b, and c are cost adjustment coefficients for each of target episodes calculated by the cost-adjustment-coefficient calculating section 111. X(i, k), Z(i, k), and U(i, k) are the same as those used in Expression (2).

Subsequently, the cost-adjustment-coefficient calculating section 111 calculates an adjusted cost ES(i), which is a totalized value of the costs after the correction for each of the target episodes, by calculating a sum of S(i,k) with respect to k. The cost-adjustment-coefficient calculating section 111 calculates an average AU(i) of U(i, k) and an average AZ (k) of Z(i,k) with respect to k. According to the procedure explained above, the cost-adjustment-coefficient calculating section 111 calculates ES(i), Au(i), and AZ(k) for each of the medical institutions.

The result output section 303 outputs a processing result including ES(i), AU(i), and AZ(k) calculated for each of the medical institutions. The output processing result is transmitted to, for example, the computer 131 of the monitoring system 130. A calculation result shown in FIG. 17 is displayed on the input/output device 136 of the computer 131.

FIG. 18 is an explanatory diagram showing an example of a display screen 1800 of a calculation result in the first embodiment of the present invention.

The display screen 1800 includes text areas 1801, 1803, and 1804 and a graph area 1802.

The text area 1801 is an area where a target episode is displayed. The graph area 1802 is an area where a graph of the adjusted cost ES(i) concerning a target episode for each of the medical institutions is displayed. The text area 1803 is an area where the average AU(i) of conformity concerning the target episode is displayed. The text area 1804 is an area where the average AZ(i) of severity concerning the target episode is displayed.

As explained above, according to the present invention, the server 101 calculates conformity representing the quality of diagnostic treatment by checking consistency of contents of the diagnostic treatment and medical knowledge information and adjusts costs using the conformity as an explanatory variable. This makes it possible to realize adjustment of the costs taking into account the quality of the diagnostic treatment. Consequently, it is possible perform efficiency evaluation of a hospital taking into account efforts concerning the diagnostic treatment of the hospital.

For example, if the quality of diagnostic treatment is high, even a medical institution having low evaluation in terms of costs evaluated using the method in the past is likely to be determined as a medical institution having high evaluation in terms of costs calculated using the present invention. That is, an effect of suppression of an outbreak of a complication or readmission in the medical institution is reflected on costs. In the present invention, it is possible to achieve the effects explained above by taking into account the quality of the diagnostic treatment.

Since the quality of the diagnostic treatment is taken into account, there is also an effect that an incentive to improve the quality of the diagnostic treatment acts in the medical institution.

Note that the various kinds of software illustrated in this embodiment can be stored in various recording media (e.g., a non-transitory storage medium) of an electromagnetic type, an electronic type, an optical type, and the like and can be downloaded to a computer through a communication network such as the Internet.

Further, in this embodiment, the example is explained in which the control by the software is used. However, a part of the control can also be realized by hardware.

The present invention is explained in detail above with reference to the accompanying drawings. However, the present invention is not limited to such a specific configuration and includes various changes and equivalent components within the gist of the appended claims.

1. A computer system that calculates a first cost of diagnostic treatment for a patient in a medical institution,
the computer system including one or more computers that include a processor, a memory connected to the processor, and an interface connected to the processor,
the computer system storing a healthcare information database for managing, as episodes, a series of medical services performed on a disease of the patient and a medical-knowledge management database for managing types of the medical services recommended for a predetermined patient, contents of the medical services, and costs of the medical services, and
the computer system comprising:
an adjustment-coefficient calculating section that calculates, using the healthcare information database and the medical-knowledge management database, an adjustment coefficient for adjusting costs of diagnostic treatment corresponding to the patient; and
a cost calculating section that calculates the first cost using the calculated adjustment coefficient, wherein
the adjustment-coefficient calculating section calculates, for each of combinations of processing target episodes and processing target patients, on the basis of consistency of the healthcare information database and the medical-knowledge management database, a first value indicating quality of the medical services for the patient, calculates, on the basis of the healthcare information database, a second value indicating severity of the processing target patient, specifies a demographic factor of the processing target patient on the basis of the healthcare information database, calculates a third value indicating the demographic factor of the processing target patient, calculates, for each of the combinations of the processing target episodes and the processing target patients, the adjustment coefficient on the basis of the quality of the medical services for the patient, the severity of the patient, and the demographic factor of the patient, and calculates, for each of the combinations of the processing target episodes and the processing target patients, a second cost by totaling costs of the medical services for the patient, and
the cost calculating section calculates, for each of the combinations of the processing target episodes and the processing target patients, a third cost using the second cost and the adjustment coefficient and calculates, for each of the processing target episodes, the first cost by totaling the third cost of the patient related to the processing target episode.

2. The computer system according to claim 1, wherein
the medical-knowledge management database includes one or more kinds of medical knowledge information for each of the predetermined diseases,
the medical knowledge information includes identification information of the processing target episode, content of a test performed on the predetermined disease, content of medication prescribed for the predetermined disease, and content a medical practice performed on the predetermined disease,
the adjustment-coefficient calculating section specifies an episode related to the processing target episode, acquires, from the healthcare information database, content of the medical service included in the specified episode, specifies the medical knowledge information corresponding to the processing target episode, and calculates, as the first value, first conformity, which is a degree of coincidence of the content of the medical service included in the specified episode with the specified medical knowledge information, by comparing the content of the medical service included in the specified episode and the specified medical knowledge information.

3. The computer system according to claim 2, wherein
the medical knowledge information includes a recommendation degree indicating priority order of a medical service recommended for the predetermined disease, and
the adjustment-coefficient calculating section calculates the first conformity using a result of the comparison and the recommendation degree included in the specified medical knowledge information.

4. The computer system according to claim 3, wherein
the medical-knowledge management database includes disease information including a type of the medical practice performed on the predetermined disease and a type of the medication prescribed for the predetermined disease, and
the adjustment-coefficient calculating section calculates second conformity to the disease information by comparing the content of the medical service included in the specified episode and the disease information and calculates third conformity as the first value on the basis of the calculated first conformity and the calculated second conformity.

5. The computer system according to claim 4, wherein the adjustment-coefficient calculating section calculates, on the basis of the healthcare information database, a cost of the processing target patient for each of the combinations of the processing target episodes and the processing target patients and calculates, for each of the combinations of the processing target episodes and the processing target patients, as the adjustment coefficient, a coefficient of a linear expression indicating a relation between the cost of the processing target patient and the first value, the second value, and the third value.

6. A cost calculating method in a computer system that calculates a first cost of diagnostic treatment for a patient in a medical institution,
the computer system including one or more computers that include a processor, a memory connected to the processor, and an interface connected to the processor, and
the computer system storing a healthcare information database for managing, as episodes, a series of medical services performed on a disease of the patient and a medical-knowledge management database for managing types of the medical services recommended for a predetermined patient, contents of the medical services, and costs of the medical services,
the cost calculating method comprising:
a first step in which the processor calculates, for each of combinations of processing target episodes and processing target patients, on the basis of consistency of the healthcare information database and the medical-knowledge management database, a first value indicating quality of the medical services for the patient and stores the first value in the memory;
a second step in which the processor calculates, on the basis of the healthcare information database, a second value indicating severity of the processing target patient and stores the second value in the memory;
a third step in which the processor specifies a demographic factor of the processing target patient on the basis of the healthcare information database, calculates a third value indicating the demographic factor of the processing target patient, and stores the third value in the memory;
a fourth step in which the processor calculates, for each of the combinations of the processing target episodes and the processing target patients, on the basis of the quality of the medical services for the patient, the severity of the patient, and the demographic factor of the patient, an adjustment coefficient for adjusting a cost of the diagnostic treatment for the patient and stores the adjustment coefficient in the memory;
a fifth step in which the processor calculates, for each of the combinations of the processing target episodes and the processing target patients, a second cost by totaling costs of the medical services for the patient and stores the second cost in the memory;
a sixth step in which the processor calculates, for each of the combinations of the processing target episodes and the processing target patients, a third cost using the second cost and the adjustment coefficient and stores the third cost in the memory; and
a seventh step in which the processor calculates, for each of the processing target episodes, the first cost by totaling the third cost of the patient related to the processing target episode and stores the first cost in the memory.

7. The cost calculating method according to claim 6, wherein
the medical-knowledge management database includes one or more kinds of medical knowledge information for each of the predetermined diseases,
the medical knowledge information includes identification information of the processing target episode, content of a test performed on the predetermined disease, content of medication prescribed for the predetermined disease, and content a medical practice performed on the predetermined disease, and
the first step includes:
an eighth step for specifying an episode related to the processing target episode;
a ninth step for acquiring, from the healthcare information database, content of the medical service included in the specified episode;
a tenth step for specifying the medical knowledge information corresponding to the processing target episode; and
an eleventh step for calculating, as the first value, first conformity, which is a degree of coincidence of the content of the medical service included in the specified episode with the specified medical knowledge information, by comparing the content of the medical service included in the specified episode and the specified medical knowledge information.

8. The cost calculating method according to claim 7, wherein
the medical knowledge information includes a recommendation degree indicating priority order of a medical service recommended for the predetermined disease, and
in the eleventh step, the first conformity is calculated using a result of the comparison and the recommendation degree included in the specified medical knowledge information.

9. The cost calculating method according to claim 8, wherein
the medical-knowledge management database includes disease information including a type of the medical practice performed on the predetermined disease and a type of the medication prescribed for the predetermined disease, and
the eleventh step includes:
a step of calculating second conformity to the disease information by comparing the content of the medical service included in the specified episode and the disease information; and
a step of calculating third conformity as the first value on the basis of the calculated first conformity and the calculated second conformity.

10. The cost calculating method according to claim 9, wherein the eleventh step includes:
a step of calculating, on the basis of the healthcare information database, a cost of the processing target patient for each of the combinations of the processing target episodes and the processing target patients; and
a step of calculating, for each of the combinations of the processing target episodes and the processing target patients, as the adjustment coefficient, a coefficient of a linear expression indicating a relation between the cost of the processing target patient and the first value, the second value, and the third value.
